(19) United States
(12) Patent Application Publication
(10) Pub. No.: US 2021/0045411 A1
(43) Pub. Date: Feb. 18, 2021

(54) Chew Stick for Dogs With Enhanced Chew Time and Flavor

(71) Applicants: David A. Andersen, Los Angeles, CA (US); Richard L. Harpe, Huntington Beach, CA (US)

(72) Inventors: David A. Andersen, Los Angeles, CA (US); Richard L. Harpe, Huntington Beach, CA (US)

(21) Appl. No.: 16/873,911

(22) Filed: Aug. 10, 2020

Related U.S. Application Data
(60) Provisional application No. 62/922,583, filed on Aug. 16, 2019.

(51) Int. Cl. A23K 10/20; A23K 20/179; A23K 20/163; A23K 20/147; A23K 40/30; A23K 50/42

(52) U.S. Cl. CPC A23K 10/20; A23K 20/179; A23K 50/42; A23K 20/147; A23K 40/30; A23K 20/163

(57) ABSTRACT

A chew stick for dogs made from strips of beef bladders or esophagus formed into sticks and infused with a solution of water, syrup and gelatin, and humectant, and other ingredients, and colored for appearance, and then heated to dehydrate the chew to about 8% to 14% moisture content to achieve the finished product. The stick may also be coated with a mixture of emulsified meat, such as beef, starch, flavoring extract, oil, and water, to give it an attractive flavoring and toughness as a finished product.

### CROSS REFERENCE TO RELATED APPLICATION

This application is a continuation of provisional patent application having Ser. No. 62/922,583, filed on Aug. 16, 2019.

### FIELD OF THE INVENTION

A chew stick for dogs has been developed with a palatability, appearance and chew time that enhances all of these characteristics, of the stick, the stick is manufactured from strips of dried beef bladder, or esophagus, cut into length of strips, the strips are dehydrated, and said strips inherently incorporate some epithelial tissue fraction that adds to the elasticity of the strips, and increases the toughness, with such tissue enhancing the percentage of toughening agents that can be infused into the bladder and other component fraction during manufacture of such treats. The addition of high heat and, if necessary, some pressure increases the infusion of the toughening agents into the strips before coating and exposure to elevated heat to dehydrate the prepared chews.

### BACKGROUND OF THE INVENTION

There is a wide selection of treats for pet owners to feed their dogs. Many of these are treats such as jerky, biscuits and extruded dehydrated cracker style products that come in many shapes and colors. The major problem with this type of product is the lack of chew time as even a small dog can rapidly consume these offerings. A wide range of chews are also made from dried rawhide that is split into thin sheets and then rolled, twisted, or tied into many different shapes. While the tough rawhide pieces result in a long lasting chew, the palatability, especially for smaller dogs is not good, and rawhide is not a totally digestible ingredient. While many manufacturers have attempted to increase the palatability with the addition of meaty flavorings onto the surface, the end result is not a product with high palatability. Some manufacturers have also attempted to make the rawhide more digestible by pretreating the rawhide splits with enzymes, but again, this may soften the product, and the end result is not optimum from a nutritional standpoint.

Manufacturers have attempted to increase the chew time with the introduction of dried animal body parts, particularly ones with toughness in the dried state. Examples of this style of products are pig ears, cattle hooves, cattle femur bones, knuckles, tendons, or pizzles.

Berends, U.S. Pat. No. 4,880,642, teaches making a stick style chew for dogs by removing the meat and fat from tendons and then baking the sticks at 200° C. until they are completely hardened. While dried versions of these animal parts result in an extended chew time, the palatability is significantly lacking after the dog has removed the outside meat fraction on such body parts. A problem can also be encountered in rug staining when any dried body part with high percentages of meat or fatty tissue remain on the surface of the chew. Some risk is also inherent in the dried bone products because of the possibility of a dog breaking a tooth while chewing the hard bones or swallowing a broken piece of bone resulting in an intestinal blockage.

One method to reduce the toughness of a dried body part is taught in Merrick, U.S. Pat. No. 5,084,297, where cattle hoofs are infused with a mixture of propylene glycol and water to soften the texture of the hoof. In an effort to increase the palatability of the somewhat unpalatable hoof product, Merrick teaches the stuffing of the cavity of the hoof with a formulation similar to ground dry dog food. This teaching however cannot result in a stick style highly palatable treat resembling bully sticks.

In order to reduce the potential hazards of some dried body parts, manufacturers have offered a treat for dogs made from dried bull or steer penis. These treats have no bone fraction, are highly palatable, and do take some time for most dogs to consume. Manufacturers are now very creative in offering a wide range of presentations of the dried penis fraction, and typical pet stores present them in shapes of sticks, rings, braids, and knots. The difference between dried bull penis and dried steer penis is simply the diameter of the chew with the bull pieces made from older cattle and the steer pieces made from younger steers.

The State regulatory bodies enforcing pet food and treat regulations, (AAFCO) American Association of Feed Control Officials have now designated a legal name for this style of treat, and they are called “pizzles” on the ingredient statement and principal display panels of the packaging. These are excellent products but are becoming hard to source as artificial insemination of cattle for breeding purposes has resulted in a significant reduction of raw material for the production of bull pizzle treats.

A need exists for a product with the palatability, chew time and appearance of dried pizzle treats to be made from something other than bull penis.

Several teachings exist that show attempts to extend the available bull penis raw material, or to manufacture a stick style of product utilizing extrusion, infusion, injection molding and similar manufacturing methods. Anderson, et al., in U.S. Pat. No. 8,479,687, teaches a method of braiding fresh bull or steer penis with bleached rawhide splits to produce a stick with a combination of the high palatability of the penis fraction with the long chew time of dried braided rawhide fraction. While this technique presents an acceptable treat, the product still contains rawhide, which is deemed non-nutritious by many pet owners.

Greenburg, U.S. Pat. No. 5,635,237, attempted to solve the appearance problem of having rawhide in the treat by melting the rawhide utilizing a twin-screw extruder and extruding sticks that could be presented in either straight pieces or tied into knots like many rawhide offerings. A meat fraction such as emulsified bull penis could be added with the starting material to provide flavoring for the finished piece. The difficulty with the Greenberg process is that the extruder must be operated at a relatively low moisture level which significantly reduces the percentage of bull penis fraction that could be utilized in the product. This same problem is evident in the teachings of Brown, U.S. Pat. No. 6,886,496, where a pre-extruded and dried log is placed inside of a rolled rawhide cylinder. Again, as with Greenberg, the overall dry meat level is not high enough for excellent palatability on finicky breeds, and also the meat reforming step in the process results in a somewhat fragile product.

Sherrill, U.S. Pat. No. 5,673,653, teaches a method of wrapping jerky sheets on the inside of a roll of rawhide in such a way that the jerky fraction extends from the ends and horizontal seam of the rawhide. This product has been successfully commercialized under the trade name “Dingo”. While this product results in a treat with much higher palatability than typical rawhide treats, it is not possible to use the teachings to result in a non-rawhide treat with the appearance of a pizzle stick.

A wide range of treats have also been developed by reforming a homogeneous formulation into an extruded, molded or injection cavity which could be in stick form to resemble a pizzle type of product. Wruk, U.S. Pat. No. 3,567,459, teaches a process of manufacturing a simulated bone from a molten thixotropic thermoset sugar composition including flavors that when deposited or extruded and cooled solidifies to a hard and non-brittle treat. The problem with this process is the difficulty of maintaining the exact temperatures needed through a two-stage process and the inability to form a three-dimensional treat such as a pizzle stick when utilizing a depositioning step. It would also result in an analytical profile that would be predominantly sugar in nature and thus unacceptable to a majority of dog owners. The reliance on sugar crystallization structure for the hardness also eliminates the ability to formulate any significant percentage of meat fraction into the formulation.

Modified injection molding equipment offers another alternative for presenting a treat in stick form which could be three-dimensional in nature and with the proper coating could have an appearance similar to pizzle sticks. In this case a formulation typically high in starch pellets is fed into the injection molding machine where the pellets are melted and injected into three-dimensional dies equipped with cooling jackets where the formulation is cooled until it sets. The pieces are then dried to form a moderately tough treat. Axelrod, U.S. Pat. No. 5,240,720, teaches a method of utilizing the milk protein casein in conjunction with gelatin to form three dimensional treats that are extremely hard if formulated with about 95% casein and 5% gelatin. The pet owner can then use a microwave oven to puff and thereby soften the treats to make such less dense for older dogs or smaller breeds. While this formulation and process could be utilized to produce a stick type of treat, the palatability is not competitive with what can be achieved with a process and formulation utilizing high levels of a meat fraction. The high cost of milk protein and the high percentage of it in the Axelrod patent makes it difficult to achieve an economically competitive product with this teaching.

Mohilef, U.S. Pat. No. 5,897,893, teaches the ability to utilize an edible tubular wrapper, such as beef esophagus, as a casing that encloses an inner bone like core. Such core can be composed of simply dried cattle bone fractions such as rib bones, extruded dried jerky style sticks, or any other formulated treat components that can be dried into a finished tubular product. The product of this invention could be made to look more like a pizzle stick by applying a coating and coloring solution to match the appearance. In fact, a product has been commercialized with this process and sold in the pet store channel under the trade name “Fetchers”. Use of these teachings does result in an end product similar to a pizzle, but the product has a very short chew time if a formulated dough is stuffed into the somewhat narrow tubular fraction and still has the problem of broken bone fragments entering the dog's digestion system if bone pieces are used for the inner core.

Coatings have been used for years by pet treat manufacturers to improve palatability and appearance of their products. Corbett, U.S. Pat. No. 4,508,741, demonstrates a wide range of alternatives for improvising the appearance of a basic biscuit treat. Matching the color of a pizzle stick by applying a surface coating to a treat is not difficult, but formulating the inner component to have the appearance, chew time and palatability of a pizzle is the difficulty. It is not possible to produce a product with a chew time competitive to penis sticks utilizing the biscuit style process of the Corbett teachings.

Another alternative approach of taking a dehydrated body part and further processing it into a formulated pet treat is taught in Levin, U.S. Pat. No. 8,057,838. Levin also patented this technology for human grade jerky style treats in U.S. Pat. No. 8,865,239. The '838 teaching starts with dehydrated cattle body parts such as snouts, ears, lungs, hearts, cartilage, and muscle and bone tissue and infuses them with a humectant solution to make the treat soft and pliable. While the technology in Levin could possibly produce a treat with the appearance of a pizzle stick if you dried and then infused a tubular stick shape body part, the teachings of this patent in all cases result in a more tender product and would not have the chew time, texture or toughness of a pizzle stick.

Other patents relating to this technology and showing this style of pet chews can be seen in U.S. Pat. No. 6,840,196, to Kirch, upon a rawhide pet chew. U.S. Pat. No. 4,702,929, to Lehn, et al, is upon a method for the manufacture of munchies for dogs and cats. U.S. Pat. No. 4,259,361 is a process for preparing a dehydrated protein product from animal matter. The patent to Kirch, U.S. Pat. No. 7,194,981, is upon a roll-up style of rawhide pet chew. The patent to Pater, et al, U.S. Pat. No. 8,137,731, shows a further style of pet chew. Finally, the patent to Andersen, et al, U.S. Pat. No. 9,380,802, shows a coated pet chew product, to add to its palatability, and wherein the chewable substrate of the product is selected from a group of bones, horns, antlers, and hooves, obtained from animals. Other patents are the patent to Levin, U.S. Pat. No. 8,865,239, and Corbett, No. U.S. Pat. No. 4,509,741.

These are examples of the variety of prior art that are published relating to this technology.

### SUMMARY OF THE INVENTION

This invention relates to a method of producing a dog chew stick with the appearance, high palatability and extended chew time of a dried penis stick known in the trade as a “pizzle”.

A chew stick for dogs has been developed with the palatability, appearance, and chew time competitive with dried beef penis sticks commonly known in the trade as bully sticks or beef or steer pizzles. The stick of this invention is manufactured from strips of dried beef bladder, or alternatively, beef esophagus strips. To match the flexibility and toughness of beef pizzles, the bladder or other sticks are infused with a marinade of hygroscopic corn, tapioca or rice syrup which also adds palatability to the product since dogs prefer a sweet background in long lasting treats. Molasses can also be used in place of or mixed with either of the other hygroscopic carbohydrates. The chew time is further extended with the addition of the hardening agent gelatin. The gelatin may be utilized alone or in combination with a milk protein such as calcium caseinate or a plant gum such as gum Arabic. A meaty coating can be added to further increase the palatability and match the appearance of bully sticks is applied onto the surface of the infused bladder or esophagus sticks prior to dehydration and final packaging.

The invention in one example starts by utilizing a beef bladder fraction and washing, slicing, and drying such bladder fraction into a stick form approximately 6″ to 18″ in length and ¾″ to ⅜″ in diameter. During dehydration the moisture level of the sticks is reduced from over 70% to less than 12%. The bladder fraction is preferred for this product because it is one of the few body part fractions containing an epithelial tissue segment and the elasticity of the epithelial tissue serves to increase the percentage of toughening agents and meaty component that can be infused into the bladder fraction during manufacture of this treat. Animal esophagus can be utilized in lieu of the bladder, and if treated properly, may exhibit as much flavor infusion and toughness in the finished product. For example, while the esophagus has very little if any epithelial tissue, which means it may not absorb as much of the hardening agent, if applied by pressurized infusion, it has been found that the finished product when tested for shear force provides as great a toughness as the usage of the bladder strips, in the finished dog chew product.

The next step in this invention involves the infusion of a hot liquid fraction that will increase palatability and toughness of the product, as well as result in an extended chew time. A food grade humectant is also soaked into the sticks which will keep them flexible and chewy, .but still tough, even after subsequent dehydration. The infusion solution is also composed of a hydroscopic carbohydrate fraction added in syrup or powder form, which maintains a slightly elevated moisture level in the finished product resulting in a flexible dog chew with an appearance and texture similar to the real beef pizzle sticks. In order to increase the toughness of the product to match the chew time of pizzle sticks, the carbohydrate fraction should be a hygroscopic product preferably with a D.E. (dextrose equivalent) in the 36 to 46 D.E. range, and a maltose percentage in the 30% to 70% range. The source of the carbohydrate is not a factor and competitive product can be made with corn syrup, rice syrup, tapioca solids or even molasses fractions. The benefits from usage of high maltose syrup is to achieve a tougher product.

Other hardening agents, such as Gum Arabic or rice starch, if necessary, in combination with the use of pressurized infusion has obtained a product that is of tougher texture and a higher level of hardening through the use of these types of ingredients. Thus, the use of pressurized infusion, in the range of 20 to 50 psi, rather than vacuum infusion, has allowed for the greater impregnating of the chew product with the desired hardening agents, to make the product of a tougher consistency and to extend its usable life, and enhanced flavor, when generally applied as a dog chew to the pet industry.

Several options exist in the selection of additional toughening agents to utilize in the infusion solution. We have found that two alternative protein fractions can best serve this function; either gelatin or a milk protein fraction, preferably calcium caseinate. We have also found that using a combination of the two ingredients results in a dog treat with the longest possible chew time.

As an alternative to the hardening agents that may be used in the fabrication of the chew product of this invention, other hardening agents such as Gum Arabic on rice starch may be utilized, as aforesaid. In addition to matching the appearance of a pet chew pizzle stick, the most important requirement for this current product is the chew time, which is best measured with shear testing equipment. A higher shear results in a chew stick with a long chew time and one almost as tough as the real pizzle stick. Numerous gum and other thickening agents were evaluated as optional ingredients for this product. In order to achieve the highest percentage of toughening agents within the stick it is necessary to incorporate as much binder as possible. This is somewhat difficult because to achieve a higher level of hardening agent, you must utilize a high percentage of solids in the infusion solution, but as the solid level increases, the liquid solution becomes too thick to penetrate into the raw material strips being treated. This is a major problem when dealing with calcium caseinate where the solubilization results in a somewhat thick solution at solids levels as low as 5% to 10%. Fortunately, calcium caseinate added considerable texture and flexibility to the end product at a low usage percentage. It was found that two other ingredients that work well to not only dissolve into the infusion solution but also to result in a significant increase in the shear of the final stick, is a food plant called Gum Arabic. The unique aspect of this material is that it can solubilize in water solutions as high as 50%. It also was able to be dissolved in warm solutions containing other main components such as gelatin and rice syrup, as identified for this product. Since the Gum Arabic was used at a high enough level to result in significant thickening of the hardening solution, under pressure or atmospheric infusion, it was found to be satisfactory for usage in this application.

Another ingredient for further toughening the end product of this development is the use of a starch. Rice starch was found most satisfactory. When pressure infused, and dried, the chew sticks, treated with these ingredients, develop a much higher shear force enhancing the hardness of the finished product, to add to its useful life. In order to achieve the highest percentage of compatible agents in the stick, such as the ingredients identified herein, it is necessary to incorporate as much binder material within the processing of the chew sticks, when made.

Alternative humectants may be utilized to result in a decreased water activity in the final product, and also to help maintain the flexibility of the finished dried chew stick. While many humectants might be considered, we have found that vegetable glycerin makes the best humectant to use to achieve the desired texture effects. Alternatively, sorbitol or propylene glycol can also be utilized as the humectant for the formulation.

Another aspect of this chew product is the application of a meaty coating that is applied to the infused bladder or esophagus pieces prior to the final drying step. The purpose of the meaty coating is to add to the attractiveness of the flavor of the chew product, that is believed to add to the appetite of the canine, when considering chewing upon the finished product.

The infusion solution is mixed in a water system to make it fluid enough to penetrate into the dried bladder sticks. The typical percentages found most effective in this invention are generally in the following ranges:

| Ingredient | % Range |
|---|---|
| Water | 0-40% |
| Gelatin or calcium caseinate | 2-10% |
| High maltose carbohydrate syrup or solids | 20-40% |
| Vegetable glycerin | 2-8% |
| Carmel color | 0-3% |

The dried bladder sticks are best marinated warm but not hot, the temperature typically in the range of 120° F. to 170° F. Below 120° it takes too long to get sufficient infusion solution to soak into the sticks, and above about 170° F. the protein in the bladder sticks will denature and curl up and distort and ruin the pizzle like appearance of the end product. Typically, a holding time of 45 minutes at 160° F. with the bladder sticks submerged in the infusion solution will result in an infusion pick-up of 18-55% on a wet weight basis.

After the sticks have been submerged for 45 minutes, any excess fluid is drained from the sticks. The product can then be placed in a tumbler to coat on a highly palatable meaty coating that not only flavors and colors the bladder sticks, but it applies a coating on the outside of the sticks that eliminates stickiness that can occur in high humidity conditions because of the hygroscopic nature of the carbohydrate fraction. As an alternative, a manufacturing step of dipping the infused sticks into a meaty coating can be utilized in place of the tumbling step.

Various tests were conducted to determine the enhanced attributes of the formulated chew sticks.

Shear strengths were measured for various examples in the formulation of the chew sticks as provided herein. Several different analytical alternatives for testing the strength of the bladder or esophagus pieces was conducted. Because of the flexibility of the sticks in addition to the hardness it was determined to use a pressure testing machine that measures the shear. The machine utilized was a Karel-Weaver Model 590 modified with an inverted V knife to cut vertically across the hardened treated sticks. With this, tests were conducted upon all the various variables described within this application. It was done by doing a shear test of five individual pieces from each set of examples and calculating the average for each variable. In testing the stick of Example 1, the shear calculated for that stick was 290 pounds pressure, and the shear strength of the Example 2 formulation for the stick was calculated at 190 pounds of pressure. The shear strength of the untreated control stick was 120 pounds. Shear results for the additional examples have already been included with the description for those tests.

Analysis was also made of the treatment of the various organs for their maximum infusion. In all cases the esophagus pieces or the bladder pieces needed to be dried to below 10% moisture prior to the infusion process, and the meaty coating step. The higher percent of hardener that can be soaked into the sticks results in the toughest sticks with the longest possible chew time for the dog. Some customization of the raw material drying process resulted in an increase in the amount of solution absorbed and thus resulting in a longer lasting chew. The majority of the factories producing the dried esophagus or bladder sticks for the identified products herein are located in South American countries. Thus, each factory has their own proprietary process for rendering and drying these body parts. Thus, the Applicants have found that some drying options result in an end product with a process that yields a tougher and longer lasting chew. Some plants will just prepare, and sun dry the body part fractions followed by a short time higher temperature heat treatment to pasteurize the product. The product produced with this method resulted in the lowest pick-up of hardening solution.

Other processes involve the use of low to moderate velocity truck ovens with the product resting on trays or hanging from racks with weights at the bottom to keep the body parts from curling. These dryers are typically run at lower temperatures of around 130° F. to 160° F. with a short time higher temperature sterilization temperature of about 175° F. that is used at the end of the drying cycle. Other more sophisticated plants will utilize very high velocity smokehouse equipment and direct hot air all around the hanging or sheeted product. Another alternative is to produce a slight “puffing” of the body part which results in the highest absorption of hardness solution with the current process of this invention. This puffing process utilizes a low level of hydrogen peroxide in the range of 5% solution to help make the product more flexible and porous and allow the evaporating moisture to expand the product. The most sophisticated techniques will utilize conventional drying equipment to dehydrate the body parts to a range of 15-25%, and then utilize impingement dryers to rapidly supply convection heat at over 212° F. which can result in the “puffing” of the almost dry body parts. A simplified type of meaty coating formulation and prepared for use for application to the infused sticks is as follows: The range of formulation for the meaty coating as applied to the sticks is herein identified.

| Ingredient | % Ranqe |
|---|---|
| Mechanically Deboned Meat | 30-70% |
| Carmel Color | 0-2% |
| Beet color | 0-1% |
| Food Starch | 5-15% |
| Water | 20-35% |

The meaty coating is mixed in an emulsifier and then applied to the surface of the bladder sticks while they are tumbling in a typical batch tumbling drum. Such tumbling drum operates at approximately 20 rpm with deflector ribs on the inside of the drum to cause constant tumbling of the infused bladder sticks until the surface of the sticks are totally covered. Typically, a 10 minute to 20 minute coating cycle will be required to achieve the desired results. If a slightly higher level of water is used in the coating, it is possible to simply dip a bulk container of the infused sticks into the meaty coating in place of the tumbling.

The infused and coated bladder sticks are then dehydrated to about 8% to about 12% moisture to achieve the finished product. Best results can be obtained by a high temperature heat setting of the starch and meat protein coating if an elevated temperature of 160-180° F. is utilized. This coagulates the meat and firmly attaches the coating to the surface of the bladder or esophagus sticks as well as resulting in a pasteurized product, particularly with regard to the elimination of salmonella, which is the microorganism of main concern in pet treat products.

The finished sticks have the appearance, palatability, and overall chew time very similar to beef penis (pizzle) sticks. The chew time is somewhat less on larger dogs than beef penis sticks because of the smaller diameter of the bladder product. The palatability however is actually better because of the fresh meat coating and background sweetness of the formulated stick.

In the dehydration final step in the process, an oven/food dehydrator may perform this function in a unitary step.

It is the principal object of this invention to provide a pet chew, comprising a chew stick, for dogs, and which has enhanced palatability, appearance, and chew time during usage.

Another object of this invention is to provide a chew stick for dogs that is formulated, basically, from strips of dried beef bladder.

Another object is to provide a chew stick made from strips of esophagus.

A further object of this invention is to provide a chew stick, to which an infused solution is applied, in order to enhance the toughness, palatability, flavor, appearance, and chew time to the finished product.

A further object of this invention is to provide an infusion solution for treatment during manufacture of a chew stick for dogs, and in which its various ingredients comprising water, syrup, gelatin, coloration, and glycerin, are added to attain the enhanced benefits as aforesaid for a chew stick for dogs.

A further object of this invention is to provide a chew stick for dogs that includes in its infusion solution the ingredient calcium caseinate in order to yield a tougher bladder or esophagus stick or end product resulting in longer chew time for dogs during usage.

These and other objects may become more apparent to those skilled in the art upon review of the Summary of the Invention as provided herein, and upon undertaking a study of the Description of its Preferred Embodiments.

### DESCRIPTION OF THE PREFERRED EMBODIMENT

The invention as previously summarized herein, and in generally describing the configuration of the chew sticks, their formulation from beef bladder, and other body part fractions, taken from processed related animals, which when treated in the manner as described herein, provides a developed chew stick for dogs with enhanced palatability, appearance, toughness, and chew time during usage.

The following examples are set forth as illustrative of this invention.

### EXAMPLE 1

Beef bladders were washed and cut into long strips and dried. Forty 6″ dried bladder sticks with a total weight of 720 grams were submerged in one gallon of infusion solution having the following formulation:

| Ingredient | % |
|---|---|
| Water | 38.0% |
| High maltose rice syrup | 51.0% |
| Gelatin | 5% |
| Carmel color | 1.0% |
| Glycerin | 5.0% |

The infusion solution was mixed up and heated to 160° F. before the bladder sticks were added. The solution was kept at 160° F. for a holding time of 45 minutes with the sticks applied therein. At the end of 45 minutes the solution was drained from the infused sticks with a resulting marinated stick weight of 935 grams. This represented a pick-up of 23% infusion solution on a wet weight basis.

The forty sticks with a weight of 935 grams were then deposited into a 5 gallon tumbler 11.5″ wide and 14.25″ deep. The tumbler had two deflectors built into the inside of the tumbler to help achieve a continuous tumbling action of the bladder sticks during a 15 minute tumbling cycle at 20 rpm. During this tumbling step the sticks were coated with a coating of the following composition:

| Ingredient | % Ranqe |
|---|---|
| Emulsified beef | 63% |
| Rice Starch | 7% |
| Carmel color | 1% |
| Beet Juice Extract | 1% |
| Water | 28% |

Thirty percent of a coating was applied on a wet weight basis (400 grams). Only 265 grams of coating stuck to the surface of the products as the remaining 135 grams stuck to the inside of the coating drum.

The coated sticks were then passed through a Wearever conveyor oven operating at a temperature of 160° F., with a retention time of 20 minutes. After coming from the conveyor oven, the sticks were stacked on 20 mesh dryer trays and dehydrated for 6 hours at 160° F. in an Excalibur food dehydrator. The final sticks had a weight of 969 grams equaling 25.7% infusion solution and coating plus 74.3% of the starting dry bladder sticks. The final sticks had a physical appearance nearly identical to commercial bully sticks (pizzles) and with a size somewhat between the sizes of a typical bully stick and a typical steer stick.

An analysis of the percentage of infusion solution that was absorbed into the formulation of Example 1, wherein various bladder batches were used, using somewhat different drying techniques in their application. The results of these tests are as follows:

| | % infusion pick up |
|---|---|
| | wet weight basis |
| Atmospheric drying approximately 90° F. | 15% |
| Atmospheric drying 90° F. with moderate | 20% |
| air circulation. | |
| Smokehouse drying with temperature control | 27% |
| and high velocity air. | |

Hydrogen peroxide treatment followed by high velocity air drying. 31%

This shows the percentage of infusion depending upon the technique for drying of the raw bladder strips, as utilized before for infusion of the solution into the treated sticks.

### EXAMPLE 2

This second example demonstrates the use of dry 42 DE corn syrup in place of the rice syrup utilized in Example 1. It also shows a method of incorporating the milk protein calcium caseinate into the infusion solution to yield a tougher bladder stick end product, which resulted in longer chew time even for large dogs. Forty 6″ long dried bladder sticks with a starting weight of 792 grams were submerged into 1 gallon of infusion solution with the following formulation:

| Ingredient | % |
|---|---|
| Water | 41.0% |
| 42 DE Corn Syrup Solids | 45.0% |
| Vegetable Glycerin | 5.0% |
| Gelatin | 3.0% |
| Calcium Caseinate | 6.0% |

The infusion solution was mixed up and heated to 160° F. The calcium caseinate was added last so that the infusion solution could be adjusted to a pH of approximately 7.1 to help with the solubilization of the milk protein fraction. The dried bladder sticks were then submerged in the solution and were held at a temperature of 160° F. for a period of 45 minutes. At the end of the 45 minutes, the infusion was drained off and the marinated bladder sticks had a weight of 1115.5 grams resulting in a composition of 29% infusion solution on a wet weight basis. The sticks were then put into the tumbler described in Example 1 and were coated with 30% of the same coating that was used in Example 1. After the coating step, the sticks had a gross weight of 1395 grams, and were dried at 175° F. for a retention time of 20 minutes in the conveyor oven described in Example 1. The sticks were then dehydrated on a batch basis (piled on top of each other) in the dehydrator outlined in Example 1. At the end of a 6 hour drying step at 160° F., the sticks had a weight of 1115 grams. The sticks were hard, but still flexible and could not be hand broken because of the combination of flexibility, toughness, and strength. When comparing these sticks to the sticks of Example 1, the sticks with the milk protein were tougher and resulted in a longer chew time when tested on even larger dogs.

Another ingredient for further toughening the end product is the use of a starch. The most functional one for this invention for increasing product toughness is rice starch, as previously reviewed. A process change is required to utilize the starch fraction with this process. Starch needs to be marinated into the raw material in an ungelatinized state. Therefore, the infusion solution needs to be kept below about 125° F. during the marinating step.

### EXAMPLE: 3

Example 3 shows an experiment using rice starch to help toughen the final dog chew stick.

| Ingredient | % |
|---|---|
| Water | 46.5% |
| High Maltose Rice Syrup | 27% |
| Gelatin | 5% |
| Carmel Color | 1% |
| Glycerin | 3% |
| Rice Starch | 17.5% |

The hardening solution was mixed and heated to 125° F., and forty, 6″ bladder sticks with a total weight of 495 grams were added. The solution was kept at 125° F. for a holding time of 45 minutes. At the end of the 45 minutes the sticks were drained and had a weight of 807 grams. This represented a pickup on a wet weight basis of 38.6%. The sticks were then tumble coated with 30% of a meaty coating, as outlined in Example 1. Following the heat setting step the sticks were dehydrated to approximately 10% moisture. The forty sticks had a final weight of 696 grams and were composed of 71% starting bladder sticks plus 29% hardener and meaty coating. The sticks had an appearance of commercial pizzle sticks and when tested showed a shear test result of 220 pounds. In the further processing of the chew sticks of this invention, the application of pressurized infusion of the thicker formulation is to use what is opposite from what has been applied in the fabrication of prior art chew sticks, where vacuum infusion was employed. The use of a reactor tank, which is a closed tank that can be pressurized, to place the starting material therein and then submerge sticks in such an infusion solution has been found satisfactory, in increasing the absorbance of the solution into the sticks through the use of pressure. The reactor tank is particularly advantageous when utilizing very thick hardening solutions that do not penetrate well into the sticks, ordinarily. Utilizing pressures from 10 psi to 50 psi have been very satisfactory in injecting the infusion solution into the stick. The pressure process also allows one to reduce the time needed to soak in the desired quantity of infusion solution. This approach has worked well when numerous hardening agents are used in the formulation or when one of the hardening agents is calcium caseinate which is a thicker component than the other options. Laboratory testing has shown the use of a pressurized vessel to force in the hardening solution to be very effective.

### EXAMPLE 4

Forty 6″ dried bladder sticks with a starting weight of 390 grams were submerged in one gallon of hardening solution at 160° F. and placed in a three gallon pot and pressured to 30 pounds of pressure. The hardening solution utilized was thicker than the one in Example 1 and had the following formulation.

| Ingredient | % |
|---|---|
| Water | 29% |
| High Maltose Rice Syrup | 40% |
| Gelatin | 5% |
| Carmel Color | 1.0% |
| Glycerin | 5.0% |
| Gum Arabic | 20% |

The batch was processed identical to the Example 1 procedure, except the gum Arabic was solubilized in the water before being mixed with the rest of the ingredients. After being removed from the pressure pot after a 45 minute hold time, the sticks had a weight of 774 grams. The pickup of hardening solution was therefore 49.6% on a wet weight basis. After the drying step the end product had a total weight of 688 grams, and a shear test result of 320 pounds of pressure. The final sticks were 57% starting bladder pieces and 43% hardener and coating.

### EXAMPLE 5

An example of the use of beef esophagus sticks as a raw material to produce a simulated pizzle or bully stick, is as follows: Twenty dried 9″ esophagus sticks with a starting weight of 560 grams were submerged in two quarts of hardening solution with the following formulation:

| Ingredient | % |
|---|---|
| Water | 48% |
| High Maltose Rice Syrup | 40% |
| Gelatin | 8% |
| Carmel Color | 1% |
| Glycerin | 3% |

With the esophagus sticks being marinated in the hardening solution at a lower temperature of 130° F. for 45 minutes, prevented distortion of the sticks. At the end of the 45 minutes the sticks had a weight gain of 666 grams. The sticks were then coated with 30% of the meaty coating used in all of the various examples herein. After coating, the sticks were dried in first a conveyor oven to heat-set the meat and then in a dehydrator to reach a lower 10% moisture content. The weight to the final product was 675 grams resulting in an end product that was 83% esophagus and 17% hardener and the meaty coating. The sticks had the appearance of commercial pizzle sticks but were somewhat less hard than processed bladder sticks and exhibited a shear strength test of 165 pounds pressure.

A final analysis of a formulation for the meaty coating when applied to the sticks after the infusion process is noted herein.

| Ingredient | % |
|---|---|
| Mechanically Deboned Beef | 63.0% |
| Rice Starch | 7% |
| Carmel Color | 1% |
| Beet Juice Extract | 1% |
| Water | 28% |

This type of a meaty coating applied to the processing sticks provides the sticks with the appearance of being a much more meat like product and consistency, to add to its attractiveness, and functions as a flavor enhancer, to further add to the attractiveness of the product for the dogs.

The description as provided herein furnishes a definition of the ingredients, in the various examples, that are used for treating various beef and steer stick like strips of bladders, and other components of such animals, such as esophagus sticks, treating the same with an infusion solution, as identified, and then heating the same to achieve a level of dehydration for the finished products for packaging and marketing to the trade. Obviously, where various percentage of ingredients and their range of usage within the various formulations as identified, could be increased, or decreased by as much as 10%, and, it is believed, will still provide an effective formulation for treating the various chew sticks, during their processing and manufacture. As an example, such as shown in EXAMPLE 5 herein, identifying the rice syrup at a 40% level, that could be decreased to a 36% level, or increased to a 44% level, and it is believed, will work just as effectively as an included ingredient. The same could be said with respect to the other percentage ranges for the various examples as set forth herein.

Variation or modifications to the subject matter of this invention may occur to those skilled in the art upon review of the development as identified herein, and upon undertaking a study of the Description of its Preferred Embodiments, in view of its various Examples. Such variations, if within the spirit of this invention, are intended to be encompassed within the scope of any claims to patent protection issuing herein. The detailed description of the invention as set forth within the Specification, is generally intended to provide an illustration of the overall subject matter of the current invention that is intended to be covered by any claims to patent protection issuing upon this invention.

We claim:

1. A chew stick for dogs with enhanced chew time, hardness, and flavor, comprising:
a chew stick formed of strips of beef, steer, or related animal parts taken from the bladder or esophagus, said strips having some inherent epithelial tissue fraction, said strips being cut to a length between about 6″ to 18″ in length, and approximately ⅜″ to ¾″ in width;
an infusion solution including a mixture of water, a toughness enhancer, a carbohydrate ingredient, humectant, and a coloring agent, the strips being soaked in said infusion solution, said infusion solution being maintained at a temperature between about 120° F. to 170° F., and soaking through submersion of said strips for about 45 minutes to three hours result in the absorption of said infusion solution into said strips between about 18-50% by weight; and
applying heat within an oven food dehydrator to the infusion solution treated strips at a temperature of about or above 160° F. for a retention time of about 6 hours to heat set and pasteurize said treated strips, and to dehydrate said strips to a moisture content of less than 12% to enhance their toughness.

2. The chew stick of claim 1 wherein said infusion solution is formulated in the following ranges:

| Ingredient | % Range |
|---|---|
| Water | 50-70% |
| Gelatin or calcium caseinate | 2-10% |
| High maltose carbohydrate syrup or solids | 20-40% |
| Vegetable glycerin | 2-8% |
| Carmel color | 0-3% |

3. The chew stick of claim 2 wherein the ingredients of the infusion solution are more specifically included in the following ranges:

| Ingredient | % |
|---|---|
| Water | 38.0% |
| High maltose rice syrup | 51.0% |
| Gelatin | 5% |
| Carmel color | 1.0% |
| Glycerin | 5.0% |

4. The chew stick of claim 1, and including a meaty coating mixed in an emulsifier and applied to the surface of the chew sticks to enhance their palatability and flavoring of the chew stick to the attraction of the dog during usage.

5. The chew stick of claim 4 wherein the meaty coating applied to the surface of the infused sticks has a formulation within approximately the following ranges:

| Ingredient | % |
|---|---|
| Mechanical, deboned beef | 30-70% |
| Rice starch | 5-15% |
| Carmel Color | 0-2% |
| Beet Color | 0-1% |
| Water | 20-35% |

6. The chew stick of claim 1 wherein said infusion solution is formulated in the following ranges:

| Ingredient | % |
|---|---|
| Water | 30-50% |
| 42 DE Corn Syrup Solids | 20-50% |
| Vegetable Glycerin | 2-8% |
| Gelatin | 2-10% |
| Calcium Caseinate | 3-8% |

7. The chew stick of claim 1 wherein said infusion solution is formulated in the following ranges:

| Ingredient | % |
|---|---|
| Water | 30-50% |
| High maltose rice syrup | 30-50% |
| Gelatin | 2-10% |
| Carmel Color | 0-3% |
| Glycerin | 2-8% |
| Rice starch | 5-20% |

8. The chew stick of claim 1 wherein said infusion solution is formulated in the following ranges:

| Ingredient | % |
|---|---|
| Water | 30-50% |
| High maltose rice syrup | 20-50% |
| Gelatin | 2-10% |
| Carmel color | 0-3% |
| Glycerin | 2-8% |
| Gum Arabic | 5-40% |

9. The chew stick of claim 1 wherein a solution of hydrogen peroxide in the range of a 5% solution applied to the raw bladder or esophagus strips initially to attain their slight puffing to enhance the absorption rate of the hardener solution into said strips during their infusion treatment.

10. The process for forming a chew stick for dogs with enhanced chew time, hardness, and flavor, comprising:
forming chew sticks prepared from strips of beef, steer, or related animal parts taken from the bladder or esophagus, said strips being cut to a length between about 6″ to 18″ in length, and approximately ⅜″ to ¾″ in width, forming an infusion solution including a mixture of water, a toughness enhancer, a carbohydrate ingredient, a humectant, and a coloring agent, and soaking said prepared strips in said infusion solution maintained at a temperature between about 120° F. to 170° F., and soaking through submersion of said strips for about forty-five minutes to result in the absorption of said infusion solution into said strips to add between about 18-50% to their weight, applying heat within an oven food dehydrator to the infusion solution treated strips at a temperature about or above 160° F. for a retention time of about six hours to heat set and pasteurize said treated strips, and to dehydrate said strips to a moisture content of less than 12%.

11. The process for preparing chew sticks of claim 10, including after preparing said chew stick strips, and before applying them to the infusion solution, treating the chew stick strips with hydrogen peroxide to produce a slight puffing of the prepared strips and to enhance their porosity to increase the absorption of the infusion solution into said strips during their processing.

12. The process for preparing chew sticks of claim 10, and including the addition of one of high maltose carbohydrate syrup or solids, high maltose rice syrup, rice starch, Gum Arabic, to the infusion solution to add to the toughening and flexibility of the infused chew stick strips during their preparation.

13. The process for preparing chew sticks of claim 10, and including preparing a meaty coating formulation of ground meat, and adding to such a coloring agent, a starch, and water, and applying said coating to the surface of the solution infused strips within a tumbler to add a meaty coating to the surface of the strips during their final processing.

14. A process for preparing chew sticks of claim 10, including preparing a meaty coating formulation of ground beef, adding the same to the infusion solution, and then soaking through submersion of said prepared strips the meat coating mixed infusion solution to provide for both flavor and toughness to the chew stick strips during their preparation.
